(19) United States
(12) Patent Application Publication
(10) Pub. No.: US 2018/0206667 A1
(43) Pub. Date: Jul. 26, 2018

(54) Beverage Cartridge and Filter Support for Disposing Therein

(71) Applicant: Darren Joseph Footz, (US)

(72) Inventor: Darren Joseph Footz, Surrey (CA)

(73) Assignee: G-PAK Technology Inc., Surrey (CA)

(21) Appl. No.: 15/414,587

(22) Filed: Jan. 24, 2017

(51) Int. Cl. A47J 31/06; B65D 85/804; B65D 25/02; B65D 43/02

(52) U.S. Cl. CPC A47J 31/0642; B65D 43/0233; B65D 25/02; B65D 85/8043

(57) ABSTRACT

The present disclosure relates to a beverage cartridge comprising an outer container, a sleeve for inserting into the outer container, and a filter support for inserting into the sleeve and for supporting a filtering material. The filter support comprises: (a) a first element comprising a first perimetral edge, a second perimetral edge opposite the first perimetral edge, and a sidewall extending therebetween, the sidewall comprising: (i) one or more channels extending between the first perimetral edge and the second perimetral edge; and (ii) one or more apertures disposed in the sidewall; and (b) a second element coupled to the first element at the second perimetral edge, the second element comprising a base of the filter support. The beverage cartridge is manufactured of materials that are biodegradable and compostable.

### TECHNICAL FIELD

The present disclosure relates to a beverage cartridge, and particularly a filter support for disposing in a beverage cartridge.

### BACKGROUND

Beverage cartridges for single-serve use minimize the time required to produce fragrant and flavour-full beverage brews. To prepare a beverage brew, a beverage cartridge is inserted into a compartment of a brewing machine. The brewing machine is activated and a fluid injector of the brewing machine penetrates the lid of the beverage cartridge and injects a brewing medium (e.g. hot water) into the beverage cartridge. The brewing medium mixes with the brewing ingredients within the beverage cartridge, and produces a brewing mix. The brewing mix percolates through a filtering material, and is extracted from the beverage cartridge by a fluid extractor that has penetrated the base of the beverage cartridge and is dispensed as a beverage.

Beverage cartridges for single-serve use generally comprise an outer container defining an inner cavity, a filtering material (e.g. filter paper) disposed within the inner cavity, and a lid. The filtering material generally separates the cavity into two chambers: (i) a first chamber occupying the space between the filtering material and the lid, the first chamber for holding the beverage ingredients such as, but not limited to, ground coffee beans, tea leaves, or cocoa powder; and (ii) a second chamber occupying the space between the filtering material and the base of the beverage cartridge. The lid covers the top opening of the beverage cartridge, and provides a barrier between an external environment and the inside of the beverage cartridge.

To prevent the fluid extractor from accidentally puncturing the filtering material during the extraction of the beverage mix, some beverage cartridges further comprise a filter guard disposed in the second chamber between the base of the cartridge and the filtering material. When the fluid extractor penetrates the base of the cartridge, the filter guard acts as a barrier between the fluid extractor and the filtering material, thereby preventing the fluid extractor from contacting or piercing the filtering material.

Many beverage cartridges for single-serve use are at least in part manufactured from petroleum-based plastic materials which are neither biodegradable nor compostable. The lid is typically made of a metal foil or a metal foil laminate, and is coupled to the container by a petroleum-based synthetic adhesive. Such non-biodegradable and non-compostable beverage cartridges typically end up in landfills and contribute to the on-going environmental concerns associated with trash disposal. To address on-going environmental concerns, there is consumer and manufacturer interest in developing biodegradable and compostable beverage cartridges for single-serve (see, for example, Footz et al., U.S. Pat. No. 8,960,489).

### SUMMARY

The present disclosure relates to a beverage cartridge, and particularly a filter support for disposing in a beverage cartridge.

It is an object of the present disclosure to provide a beverage cartridge that is biodegradable and compostable, and manufactured in the absence of petroleum-based plastic materials and/or petroleum-based synthetic adhesive.

According to an aspect of the disclosure, there is a filter support for a beverage cartridge, the filter support comprising: (a) a first element comprising a first perimetral edge, a second perimetral edge opposite the first perimetral edge, and a sidewall extending therebetween, the sidewall comprising: (i) one or more channels extending between the first perimetral edge and the second perimetral edge; and (ii) one or more apertures disposed in the sidewall; and (b) a second element coupled to the first element at the second edge, the second element comprising a base of the filter support.

According to an aspect of the disclosure, there is a filter support for a beverage cartridge, the filter support comprising: (a) a first element comprising a first perimetral edge, a second perimetral edge opposite the first perimetral edge, and a sidewall extending therebetween, the sidewall comprising: (i) one or more channels extending between the first perimetral edge and the second perimetral edge; and (ii) one or more apertures disposed in the sidewall; and (b) a second element coupled to the first element at the second edge, the second element comprising a base of the filter support; wherein the one or more apertures are disposed in the one or more channels.

According to an aspect of the disclosure, there is a filter support for a beverage cartridge, the filter support comprising: (a) a first element comprising a first perimetral edge, a second perimetral edge opposite the first perimetral edge, and a sidewall extending therebetween, the sidewall comprising: (i) one or more channels extending between the first perimetral edge and the second perimetral edge; and (ii) one or more apertures disposed in the sidewall; and (b) a second element coupled to the first element at the second edge, the second element comprising a base of the filter support; wherein the sidewall comprises a plurality of channels extending between the first edge and the second edge.

According to an aspect of the disclosure, there is a filter support for a beverage cartridge, the filter support comprising: (a) a first element comprising a first perimetral edge, a second perimetral edge opposite the first perimetral edge, and a sidewall extending therebetween, the sidewall comprising: (i) one or more channels extending between the first perimetral edge and the second perimetral edge; and (ii) one or more apertures disposed in the sidewall; and (b) a second element coupled to the first element at the second edge, the second element comprising a base of the filter support; wherein the second element comprises a first sidewall extending between the second edge of the first element and the base of the filter support, and wherein the first sidewall comprises one or more channels extending between the second edge of the first element and the base of the filter support.

According to an aspect of the disclosure, there is a filter support for a beverage cartridge, the filter support comprising: (a) a first element comprising a first perimetral edge, a second perimetral edge opposite the first perimetral edge, and a sidewall extending therebetween, the sidewall comprising: (i) one or more channels extending between the first perimetral edge and the second perimetral edge; and (ii) one or more apertures disposed in the sidewall; and (b) a second element coupled to the first element at the second edge, the second element comprising a base of the filter support; wherein the first sidewall extends away from the second edge of the first element and converges towards and terminates at the base of the filter support, wherein the first sidewall extends between the second edge of the first element and an edge of the second element that is in between the second edge of the first element and the base of the filter support, and a second sidewall that extends between the edge of the second element and the base of the filter support, and wherein the first sidewall comprises one or more channels extending between the second edge of the first element and the edge of the second element.

According to another aspect of the disclosure, there is a filter support manufactured of poly-lactic acid or poly-L-lactide.

According to another aspect of the disclosure, there is a beverage cartridge comprising: (a) an outer container comprising a perimetral rim, a base, and a sidewall extending therebetween; (b) a sleeve couplable to an inner surface of the outer container; (c) a filter support couplable to an inner surface of the sleeve at least at the base of the filter support, the filter support comprising: (i) a first element comprising a first perimetral edge, a second perimetral edge, and a sidewall extending therebetween, the sidewall comprising: (A) one or more channels extending between the first perimetral edge and the second perimetral edge; and (B) one or more apertures disposed in the sidewall; and (ii) a second element coupled to the first element at the second perimetral edge, the second element comprising a base of the filter support; and (d) a filtering material that is coupled to at least an inner surface or an outer surface of the first element of the filter support, the filtering material overlying the one or more apertures of the first element.

This summary does not necessarily describe the entire scope of all aspects of the disclosure. Other aspects, features and advantages will be apparent to those of ordinary skill in the art upon review of the following description of specific embodiments.

### BRIEF DESCRIPTION OF THE DRAWINGS

In the accompanying drawings, which illustrate one or more exemplary embodiments:

FIG. 1 is an exploded view of a beverage cartridge comprising an outer container, a sleeve for inserting into the outer container, and a filter support for inserting into the sleeve.

FIG. 2 is a top view of the beverage cartridge depicted in FIG. 1.

FIG. 3 is a bottom view of the beverage cartridge depicted in FIG. 1.

FIG. 4 is a side view of the beverage cartridge depicted in FIG. 1.

FIG. 5 is a perspective view of the beverage cartridge depicted in FIG. 1.

FIG. 6 is a side view of a filter support according to an embodiment.

FIG. 7 is a perspective view of the filter support depicted in FIG. 6.

FIG. 8 is a cross-sectional view of a beverage cartridge comprising the filter support depicted in FIG. 6.

FIG. 9 is a side view of a filter support according to another embodiment.

FIG. 10 is a perspective view of the filter support depicted in FIG. 9.

FIG. 11 is a cross-sectional view of a beverage cartridge comprising the filter support depicted in FIG. 9.

FIG. 12 is a cross-sectional view of a beverage cartridge comprising the filter support depicted in FIG. 6, wherein the base of the beverage cartridge is penetrated by a fluid extractor, and the lid of the beverage cartridge is penetrated by a fluid injector.

### DETAILED DESCRIPTION

In the description, directional terms such as “top,” “bottom,” “upwards,” “downwards,” “vertically,” and “laterally” are used in the following description for the purpose of providing relative reference only, and are not intended to suggest any limitations on how any article is to be positioned during use, or to be mounted in an assembly or relative to an environment. Terms such as “connected”, “connecting”, “attached”, “attaching”, “joined”, and “joining” are used interchangeably and refer to one structure or surface being secured to another structure or surface or integrally fabricated in one piece unless expressly described otherwise.

The present disclosure relates to a beverage cartridge, and particularly a filter support for disposing in a beverage cartridge. In this disclosure, the following terms have the following meanings.

“Biodegradable” means capable of degrading as a result of the action of naturally occurring living organisms such as bacteria, fungi, and algae.

“Compostable” means capable of undergoing degradation by biological processes during composting to yield at least carbon dioxide gas, water, and biomass and leaving no visible, distinguishable or toxic residue.

“Readily renewable resource” means that the resource is derived from plant materials which grow abundantly or rapidly. Examples of readily renewable resources include, but are not limited to, bamboo and bagasse.

### Beverage Container

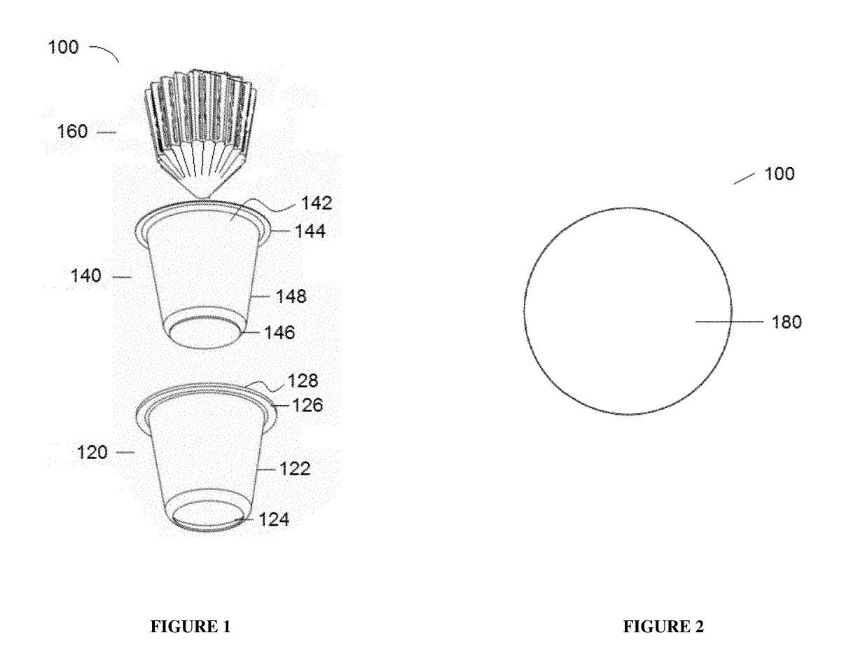

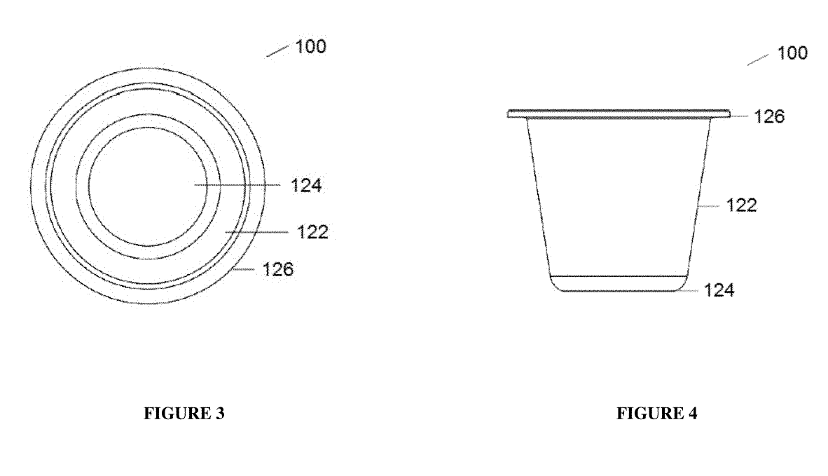

Referring to FIGS. 1 to 5, there is a beverage cartridge 100 comprising an outer container 120, a sleeve 140 for inserting into the outer container 120, a filter support (as exemplified by filter support 160) for inserting into the sleeve 140 and for supporting a filtering material (not shown), and a lid 180 for separating the inside of the beverage cartridge 100 from an external environment.

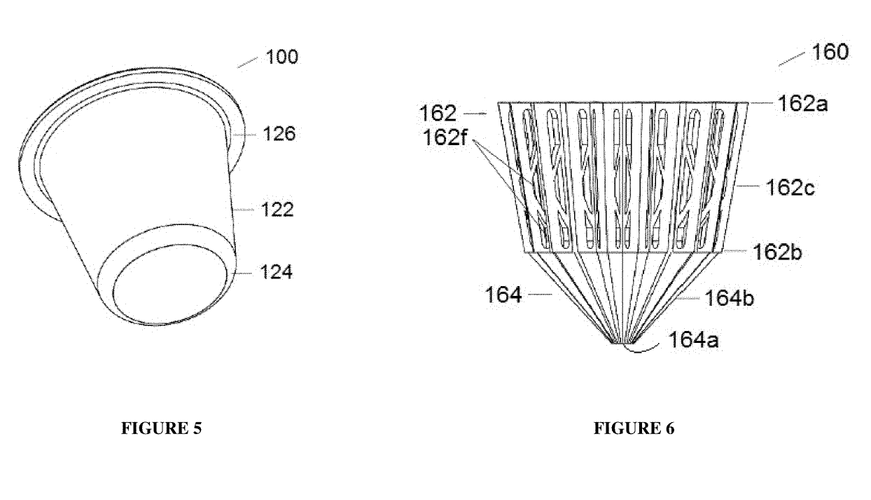

The outer container 120 comprises a perimetral rim 126 surrounding an opening 128, a base 124, and a sidewall 122 extending between the base 124 and the rim 126. The outer container 120 acts as a gas and light barrier for preserving the quality of the beverage ingredients disposed within the beverage cartridge 100. As contemplated herein, the outer container 120 is made of a biodegradable and compostable material derived from readily renewable resources such as, but not limited to, bamboo, bagasse, wheat, sugar cane, and other fibrous plant materials. The shape of the container is preferably one that is compatible with brewing machines. As depicted in FIGS. 4-5, the outer container 120 is frusto-conical in shape. However, the outer container may be of any other suitable shape including, but not limited to, a square prism and a rectangular prism.

The outer container 120 contains the sleeve 140. The sleeve 140 comprises a perimetral rim 144, a base 146, and a sidewall 148 extending therebetween. The sleeve 140 is coupled to the inner surface of the container 120 by methods known in the art such as, but not limited to, heat melting. The sleeve 140 provides a gas and moisture impermeable barrier between the outer container 120 and the inside of the beverage cartridge 100, and imparts structural rigidity to the beverage cartridge 100. The rim 144, base 146 and sidewall 148 of the sleeve 140 define an interior space 142. Since most beverages are brewed at or below 100° C. (i.e. the boiling point of water under atmospheric pressure), the sleeve 140 is preferably manufactured (for example, by vacuum forming) of a material that has a melting point that is greater than 100° C. under atmospheric pressure. As contemplated herein, the sleeve 140 is manufactured of a suitable biodegradable, compostable polymer, such as, but not limited to, poly-lactic acid (PLA) and poly-L-lactide (PLLA), or a material comprising a suitable biodegradable, compostable polymer. However, the sleeve 140 may be manufactured of any suitable material known in the art having a melting point that is greater than 100° C. under atmospheric pressure. Preferably, the shape of the sleeve 140 is complementary to the shape of the container 120. As depicted in FIG. 1, the sleeve 140 is frusto-conical in shape, and lines an inner surface of the outer container 120. In other embodiments, however, the sleeve may be of any other suitable shape including, but not limited to, a square prism and a rectangular prism.

The filter support is insertable into the interior space 142, and comprises a first element and a second element. The first element comprises a first perimetral edge, a second perimetral edge opposite the first perimetral edge, and a sidewall extending therebetween. The sidewall comprises: (i) one or more channels extending between the first perimetral edge and the second perimetral edge; and (ii) one or more apertures disposed in the sidewall. The second element is coupled to the second perimetral edge of the first element, and comprises a base of the filter support. The second element also defines a spatial volume between the second perimetral edge and the base of the filter support, the spatial volume for containing at least a portion of a beverage ingredient.

The filter support is preferably rigid for imparting structural rigidity to the beverage cartridge 100, and is preferably made of a biodegradable and compostable material such as, but not limited to, PLA and PLLA, or a combination of biodegradable and compostable materials. However, the filter support may be manufactured of any suitable material known in the art having a melting point that is greater than 100° C. under atmospheric pressure, and by a suitable method known in the art (for example, but not limited to, injection molding). The filter support may be of any suitable shape as long as the filter support is insertable and couplable to the sleeve 140. As contemplated herein, the filter support is couplable to the sleeve 140 at least at the base of the filter support by a suitable method known in the art such as, but not limited to, hot melting. In addition, the filter support may be integrally formed as one piece, or the first element and the second element may be detachably coupled to each other.

Filtering material (not shown) such as, but not limited to, filter paper is coupled to at least the outer surface or inner surface of the first element of the filter support such that the filtering material overlies the apertures of the sidewall of the first element. The filtering material is coupled to the filter support according to any method known in the art. For example, the filtering material is coupled to the filter support by melting a surface of the filter support and adhering the filtering material to the melted surface. The filter support is then rapidly cooled, thereby securely engaging the filtering material. The surface melt temperature is kept below a temperature that would damage, burn or otherwise affect the structural integrity of the filter support.

The lid 180 seals the opening 128 of the container 120 and provides a barrier (preferably a gas and moisture impermeable barrier) between the inside of the beverage cartridge 100 and an external environment. As contemplated herein, the lid 180 is made of a biodegradable, compostable materials (such as, but not limited to, PLA and PLLA), renewable resources, or a combination of thereof. The lid 180 is coupled to at least a portion of the perimetral rim 126 of the container 120 by methods known in the art such as, but not limited to, hot pressing.

### Filter Support

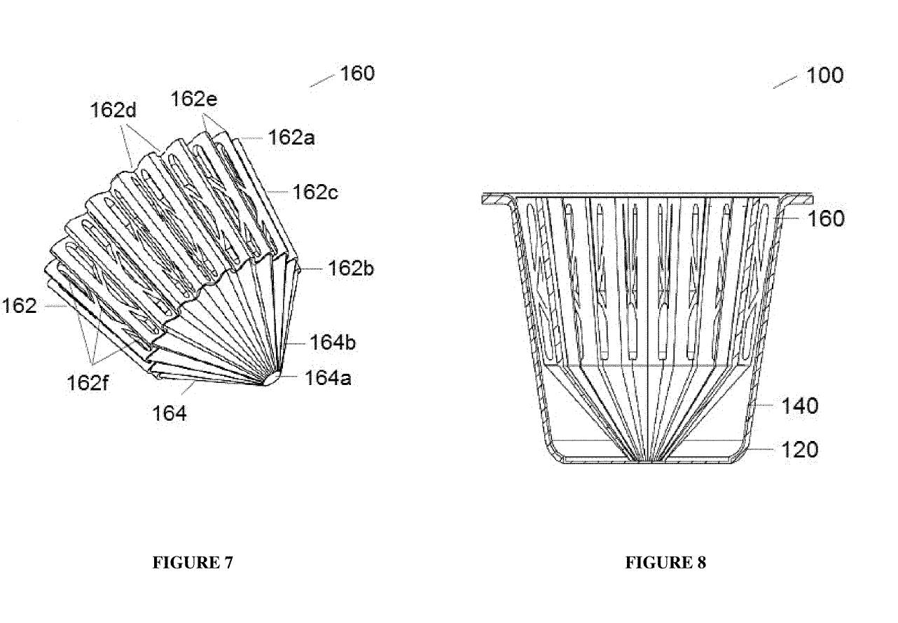

Referring to FIGS. 6 to 8, and according to an embodiment of the filter support, there is a filter support 160 comprising a first element 162 and a second element 164. The first element 162 comprises a first perimetral edge 162a, a second perimetral edge 162b opposite the first perimetral edge 162a, and a sidewall 162c extending therebetween. The second perimetral edge 162b demarcates the first element 162 from the second element 164. The first element 162 further comprises a plurality of channels 162d that are even spaced around the sidewall 162c. Each channel 162d extends the entire width of the sidewall 162c from the first perimetral edge 162a to the second perimetral edge 162b. As a result, the sidewall 162c comprises a plurality of alternating channels 162d and protrusions 162e, thereby imparting a fluted shape to the sidewall 162c and increasing the contact surface area of the sidewall 162c. Each channel 162d also comprises a plurality of apertures 162f.

The second element 164 comprises a base 164a and a sidewall 164b that extends between the base 164a and the second perimetral edge 162b. The base 164a is distal to the first element 162, and covers an area that is less than an area surrounded by the second perimetral edge 162b. The sidewall 164b extends away from the second perimetral edge 162b and inwardly slopes towards and terminates at the base 164a. The sidewall 164b preferably has a sloping angle relative to second perimetral edge 162b of between about 30° and about 60°. As used herein, the term “about” provides ±10% tolerance of the recited value. As depicted in this embodiment of the filter support, the sidewall 164b comprises a plurality of channels and protrusions (un-numbered) extending the width of the sidewall 164b, and does not have any apertures. However, in other embodiments, the sidewall 164b may be of any suitable texture such as, but not limited to, smoothened or pleated, or may comprise one or more apertures therein. For such other embodiments comprising one or more apertures in the sidewall 164b, filtering material is coupled to the outer surface or inner surface of the sidewall 164b such that the filtering material overlies the apertures therein.

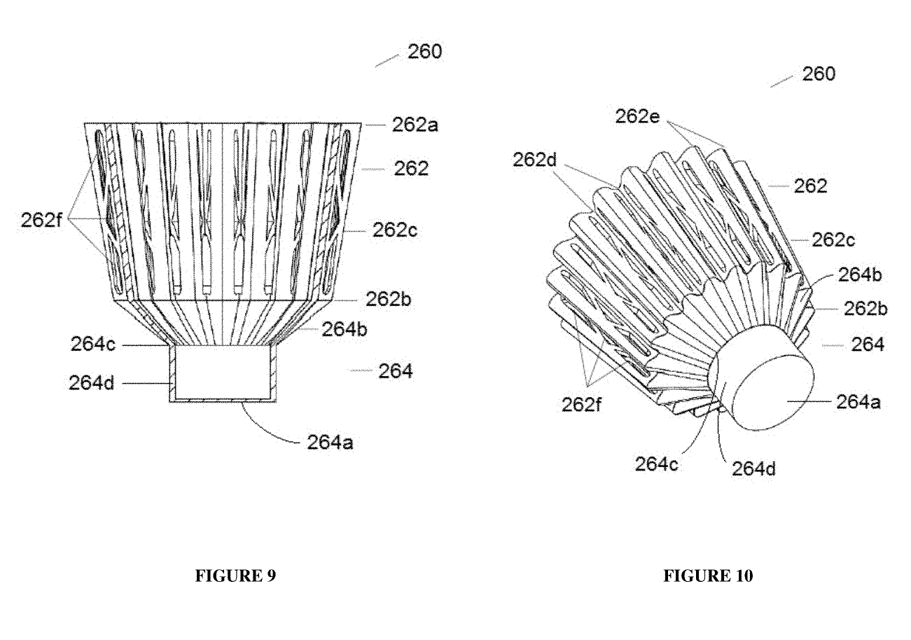

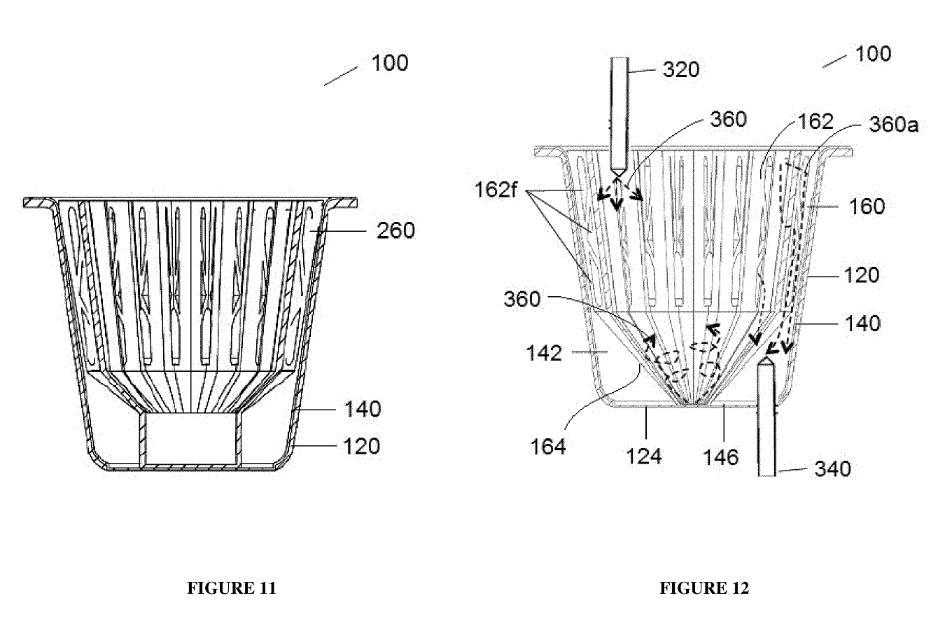

Referring to FIGS. 9 to 11 and according to another embodiment of the filter support, there is a filter support 260 comprising a first element 262 and a second element 264. The first element 262 is defined by a first perimetral edge 262a, a second perimetral edge 262b opposite the first perimetral edge 262a, and a sidewall 262c extending therebetween. The second perimetral edge 262b demarcates the first element 262 from the second element 264. The first element 262 comprises a plurality of channels 262d that are even spaced around the sidewall 262c. Each channel 262d extends the entire width of the sidewall 262c from the first perimetral edge 262a to the second perimetral edge 262b. As a result, the sidewall 262c comprises a plurality of alternating channels 262d and protrusions 262e, thereby imparting a fluted shape to the sidewall 262c and increasing the contact surface area of the sidewall 262c. Each channel 262d also comprises a plurality of apertures 262f.

The second element 264 comprises a third perimetral edge 264c, a sidewall 264b extending between the second perimetral edge 262b and the third perimetral edge 264c, a base 264a located distal to the second perimetral edge 262b and the third perimetral edge 264c, and a sidewall 264d extending between the base 264a and the third perimetral edge 264c. The area surrounded by the third perimetral edge 264c is less than the area surrounded by the second perimetral edge 262b. The sidewall 264b extends away from the second perimetral edge 262b and inwardly slopes towards and terminates at the third perimetral edge 264c. The sidewall 264b preferably has a sloping angle relative to the second perimetral edge 262b of between about 30° and about 60°. As depicted in this embodiment of the filter support, the sidewall 264b comprises a plurality of channels and protrusions (un-numbered) extending the width of the sidewall 264b, and does not have any apertures. However, in other embodiments, the sidewall 264b may be of any suitable texture such as, but not limited to, smoothened or pleated, or may comprise one or more apertures therein. For such other embodiments comprising one or more apertures in the sidewall 264b, filtering material is coupled to the outer surface or inner surface of the sidewall 264b such that the filtering material overlies the apertures therein.

Sidewall 264d of the second element 264 extends away from the third perimetral edge 264c and terminates at the base 264a. The base 264a and the sidewall 264d define a spatial volume below the third perimetral edge 264c, the spatial volume for containing at least a portion of a beverage ingredient. As depicted in FIGS. 9-10, the base 264a and the sidewall 264d define a cylindrical spatial volume. However, said defined spatial volume may be of any suitable shape including, but not limited to, a square prism and a rectangular prism. As depicted in FIGS. 9-10, the sidewall 264d is smoothened and does not comprise any apertures. In other embodiments however, the sidewall 264d may be of any suitable texture such as, but not limited to, ridged or pleated, and may comprise one or more apertures. For such other embodiments comprising one or more apertures in the sidewall 264d, filtering material is coupled to the outer surface or inner surface of the sidewall 264d such that the filtering material overlies the apertures therein.

As contemplated in this embodiment, the filter support 260 is one integral piece. In other embodiments, the first element 262 and the second element 264 are detachably coupled to each other. In other embodiments, the sidewall 264d is detachably coupled to the sidewall 264b.

### Use of a Beverage Cartridge

Referring to FIG. 12, and using a beverage cartridge 100 comprising a filter support 160 as an example, the beverage cartridge 100 is introduced into a brewing machine (not shown). The brewing machine is activated, and a fluid injector 320 of the brewing machine punctures the lid (not shown) of the beverage cartridge 100 and introduces a brewing medium 360 (e.g. hot water) into at least the second element 164 of the filter support 160 containing a brewing ingredient (not shown). In practice, the brewing ingredient may be confined to the spatial volume defined by the second element 164 or may be present in both the spatial volumes defined by the first element 162 and the second element 164. The brewing medium 360 mixes with the brewing ingredient to form a brewing mix 360a. Without wishing to be bound by theory, it is believed that a fluted second element 164 improves the mixture of brewing medium 360 and brewing ingredients, thereby improving the extraction of flavours from the brewing ingredients. The brewing mix 360a then percolates through the filtering material (not shown) and the apertures 162f of the filter support 160, and towards the base 146 of the sleeve 140. The channels 162d in the sidewall 162c of the first element 162 guide the brewing mix 360a towards the base 146 of the sleeve 140. A fluid extractor 340 penetrates the base 124 of the cartridge and enters the interior space 142 between the base 146 of the sleeve 140 and the sidewall 164b of the filter support 160. The brewing mix 360a is then extracted from the cartridge 100 by the fluid extractor 340, and eventually dispensed as a beverage.

It is contemplated that any part of any aspect or embodiment discussed in this specification can be implemented or combined with any part of any other aspect or embodiment discussed in this specification. While particular embodiments have been described in the foregoing, it is to be understood that other embodiments are possible and are intended to be included herein. It will be clear to any person skilled in the art that modification of and adjustment to the foregoing embodiments, not shown, is possible.

What is claimed is:

1. A filter support for a beverage cartridge, the filter support comprising:
(a) a first element comprising a first perimetral edge, a second perimetral edge opposite the first perimetral edge, and a sidewall extending therebetween, the sidewall comprising: (i) one or more channels extending between the first perimetral edge and the second perimetral edge; and (ii) one or more apertures disposed in the sidewall; and
(b) a second element coupled to the first element at the second perimetral edge, the second element comprising a base of the filter support.

2. The filter support according to claim 1, wherein the one or more apertures is disposed in the one or more channels.

3. The filter support according to claim 1, wherein the sidewall comprises a plurality of channels extending between the first perimetral edge and the second perimetral edge.

4. The filter support according to claim 1, wherein the second element comprises a first sidewall extending between the second perimetral edge of the first element and the base of the filter support.

5. The filter support according to claim 4, wherein the first sidewall extends away from the second perimetral edge of the first element and inwardly slopes towards and terminates at the base of the filter support.

6. The filter support according to claim 5, wherein the first sidewall comprises one or more channels extending between the second perimetral edge of the first element and the base of the filter support.

7. The filter support according to claim 5, wherein one or more apertures is disposed in the first sidewall.

8. The filter support according to claim 4, wherein the first sidewall extends between the second perimetral edge of the first element and a first perimetral edge of the second element disposed between the second perimetral edge of the first element and the base of the filter support, and a second sidewall that extends between the first perimetral edge of the second element and the base of the filter support.

9. The filter support according to claim 8, wherein the first sidewall comprises one or more channels extending between the second perimetral edge of the first element and the first perimetral edge of the second element.

10. The filter support according to claim 8, wherein the second sidewall comprises one or more channels extending between the first perimetral edge of the second element and the base of the filter support.

11. The filter support according to claim 8, wherein one or more apertures is disposed in the first sidewall, the second sidewall, or both.

12. The filter support according to claim 1, wherein the filter support is manufactured of poly-lactic acid or poly-L-lactide.

13. A beverage cartridge comprising:
(a) an outer container comprising a perimetral rim, a base, and a sidewall extending therebetween;
(b) a sleeve couplable to an inner surface of the outer container;
(c) a filter support according to claim 1 and couplable to an inner surface of the sleeve at least at the base of the filter support; and
(d) a filtering material that is coupled to at least an inner surface or an outer surface of the first element of the filter support, the filtering material overlying the one or more apertures of the first element.

14. The beverage cartridge according to claim 13, further comprising a lid coupled to at least the perimetral rim of the outer container.

15. The beverage cartridge according to claim 14, further comprising a brewing ingredient at least disposed in a spatial volume defined by the second element.

16. The beverage cartridge according to claim 14, wherein the lid is coupled to the perimetral rim of the outer container by hot pressing.
